(19) United States
(12) Patent Application Publication
(10) Pub. No.: US 2015/0020718 A1
(43) Pub. Date: Jan. 22, 2015

(54) FOLDING IMPLEMENT FOR THE PREPARATION OF SEED BEDS

(71) Applicant: Bigham Brothers, Inc., Lubbock, TX (US)

(72) Inventor: Thomas E. Pitonyak, Little Rock, AR (US)

(21) Appl. No.: 14/335,755

(22) Filed: Jul. 18, 2014

Related U.S. Application Data
(60) Provisional application No. 61/847,938, filed on Jul. 18, 2013.

(51) Int. Cl. A01B 73/04; A01B 3/24; A01C 7/08; A01B 29/06; A01C 5/06; A01B 29/04; A01B 49/02

(52) U.S. Cl. CPC A01B 73/044; A01B 29/048; A01B 3/24; A01B 49/027; A01B 29/06; A01C 5/066; A01C 7/08
USPC 111/69; 172/459

(57) ABSTRACT

A folding implement that facilitates planting operations and optimization of irrigation and drainage with efficient preparation, configuration, and planting of seed beds. A centrally located fixed drum roller supports a pair of hinged outboard drum roller wings that for maximum implement width are deployed in alignment with the main section during operation. The wings are hydraulically folded into a compact upright position for legal transport over public roads. The implement is constructed so as to provide strength and durability comparable to single-section furrow rollers. The wings include double sets of crumbler baskets for the preparation of seed beds, where the crumbler baskets are moved along with the folding wings.

### CROSS-REFERENCE TO RELATED APPLICATION

This application claims priority in U.S. Provisional Patent Application No. 61/847,938, filed Jul. 18, 2013, which is incorporated herein by reference.

### BACKGROUND OF THE INVENTION

1. Field of the Invention

The present invention relates generally to a folding agricultural implement and more specifically to an agricultural implement for the preparation of seed beds using a folding furrow chopper and a folding furrow crumbler which fold in for transport and fold out to work.

2. Description of the Related Art

Agricultural implements for preparing fields and configuring seed beds are well known in the art. Many of these agricultural implements employ earth working tools which are mounted on horizontally disposed frames to permit the implements to work wide swaths of earth. One example of such an implement is a combination of a furrow chopper and furrow crumbler which utilizes plowshares and heavy rollers connected to the frames to prepare and configure seed beds. As the furrow roller is drawn through the field, the plowshares dig irrigation furrows that produce raised earthen mounds between the furrows, and the rollers smooth and compact these raised earthen mounds so as to create uniform raised seed beds separated by uniform irrigation furrows.

Working as wide a swath of earth as possible reduces the number of passes by the implement and the overall field preparation and configuration time. Consequently, the overall width of many of the agricultural implements has increased over time. The increased width, however, makes transport along public roads and highways difficult. In order to facilitate the transport and storage of these implements, the implement frames typically have been designed to utilize a main frame having one or more wing frames or members. These wing frames are typically connected to laterally opposite sides of the main frame so that the wing frames may be raised from positions that are substantially coplanar with the main frame (extended-working positions) to positions wherein the wing frames generally overlie or are generally perpendicular to the main frame (folded-transport or storage positions).

While the utilization of wing frames facilitates both objectives of working wide swaths of earth and transporting the implement along public roads and highways, the increased width of the implement while in the extended-working position together with the weight of the applicable earth working tools imposes significant axial and torsional forces that negatively impact the operational functionality of the implement. Accordingly, it would be beneficial to have an implement with wing frames that can support the applicable earth working tools and also manage the axial and torsional forces that are encountered when the wing frames are in the extended-working position.

### SUMMARY OF THE INVENTION

In the practice of the present invention, a preferred embodiment folding agricultural implement a towable implement with a central frame and at least one foldable wing member. Implement tools, such as crumbler baskets, cutter baskets, cylindrical rollers, and plowshares are connected to each of the center frame and the wing member. Tools affixed to the wing members are carried with the wing member between a first, working position which is generally parallel to the central frame, and a second, transport position which is generally perpendicular to the central frame. This allows the implement to be transported and/or stored with ease.

### BRIEF DESCRIPTION OF THE DRAWINGS

The accompanying drawings illustrate the principles of the present invention and an exemplary embodiment thereof.

FIG. 1 is a front isometric view of an embodiment of the present invention in an open, working position.

FIG. 2 is a rear isometric view thereof

FIG. 3A is top plan view of the embodiment shown in a folded, transport position.

FIG. 3B is a rear isometric view thereof.

FIG. 3C is a rear elevational view thereof.

FIG. 3D is a side elevational view thereof.

FIG. 4A is a top plan view of a component of a preferred embodiment of the present invention.

FIG. 4B is a side elevational view thereof.

FIG. 5 is an isometric view thereof.

FIG. 6A is a top plan view of a component of a preferred embodiment of the present invention.

FIG. 6B is a side elevational view thereof.

FIG. 6C is an isometric view thereof

FIG. 7A is a top plan view of an alternative embodiment component of a preferred embodiment of the present invention

FIG. 7B is a side elevational view thereof.

FIG. 7C is an isometric view thereof.

FIG. 8A is a top plan view of a component of a preferred embodiment of the present invention

FIG. 8B is an isometric view thereof.

FIG. 8C is a front elevational view thereof.

FIG. 8D is a side elevational view thereof.

FIG. 9 is a front-elevational view of an embodiment of the present invention.

FIG. 10 is an isometric view of an embodiment of the present invention shown in a partially folded orientation.

FIG. 11 is a side elevational view of an embodiment of the present invention.

FIG. 12 is a detailed isometric view of a portion of an embodiment of the present invention.

FIG. 13 is a finer detailed isometric view thereof.

FIG. 14 is a detailed isometric view of a component of the present invention.

FIG. 15 is a front elevational view of an embodiment of the present invention shown in a partially folded orientation.

FIG. 16 is an isometric view of a preferred embodiment of the present invention in a first, working orientation.

FIG. 17 is a front elevational view thereof.

FIG. 18 is an isometric view thereof, showing the present invention in a second, folded orientation.

### DETAILED DESCRIPTION OF THE PREFERRED EMBODIMENT

### I. Introduction, Environment, and Preferred Embodiment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

Generally speaking, the present invention contemplates a folding furrow chopper and a folding furrow crumbler (individually and collectively, the “Implement”) that has wing members that may be selectively deployed from a folded-transport or storage position to an extended-working position that increases the overall width of the Implement, and that is capable of managing the axial and torsional forces that are encountered when the wing members are in the extended-working position so as to permit the Implement to efficiently prepare, configure, and plant fields without having to remove prior crops or their remains or, as applicable, dirt clods with the result being fields that have uniform furrows and elevated seed beds.

### II. Folding Furrow Chopper

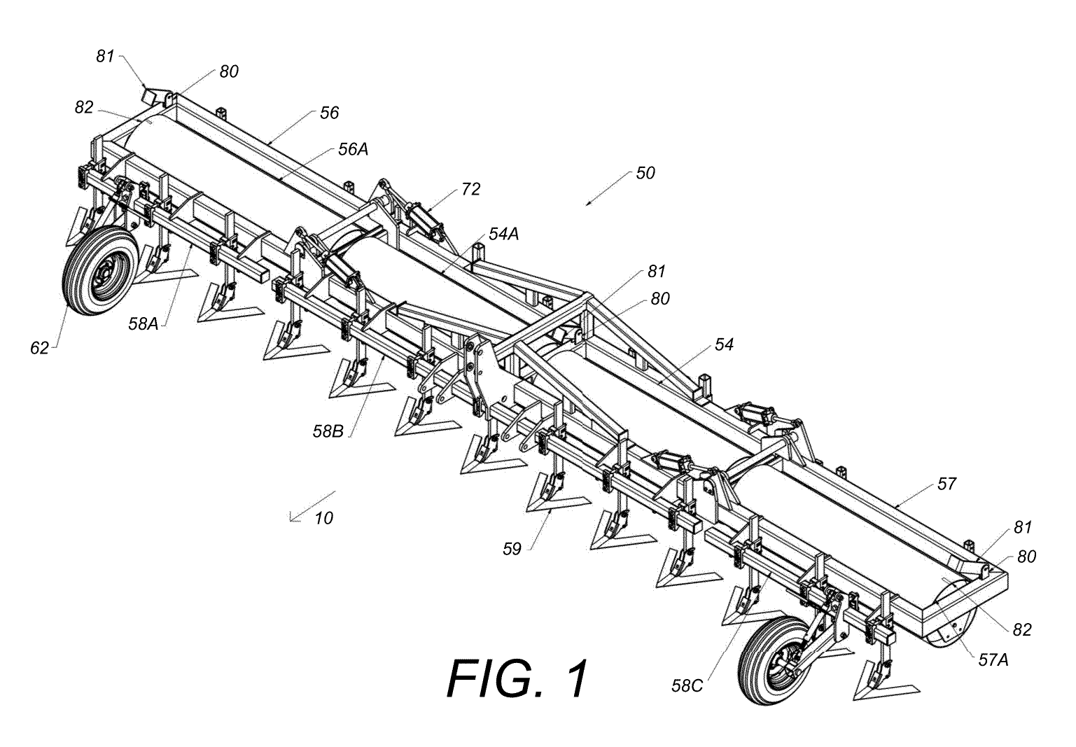

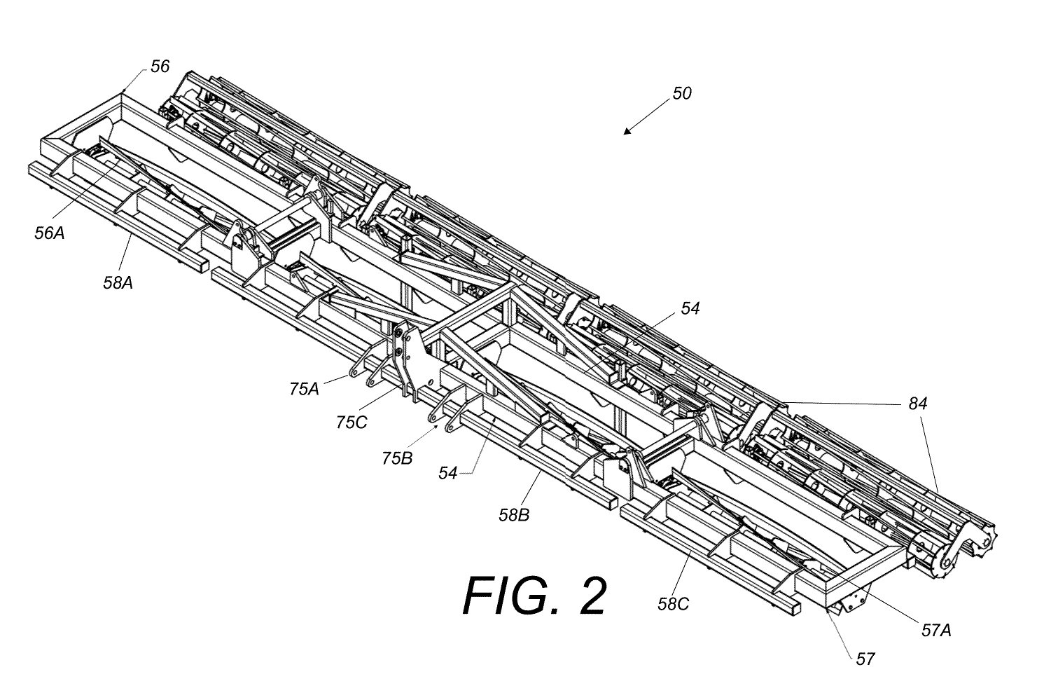

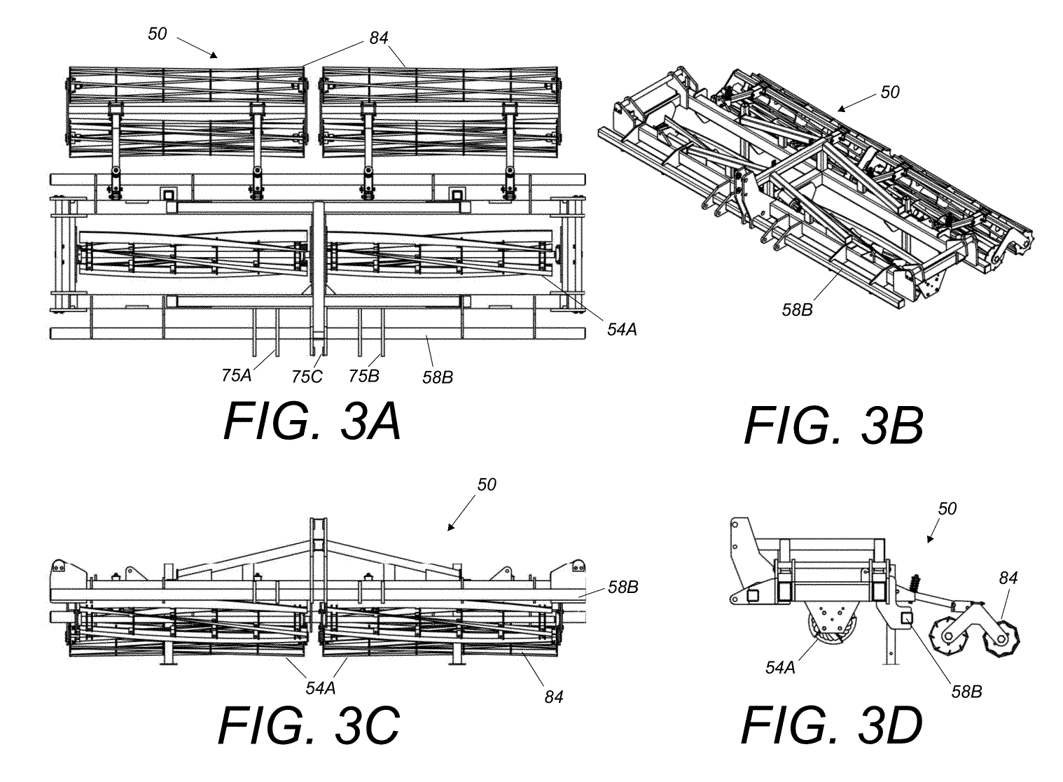

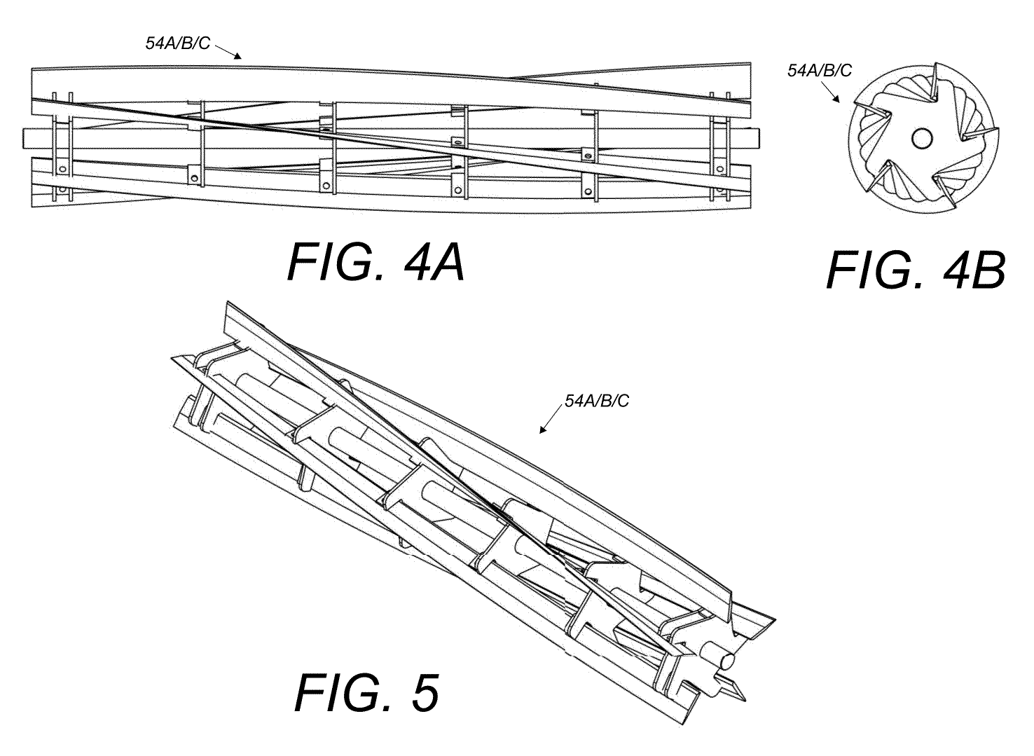

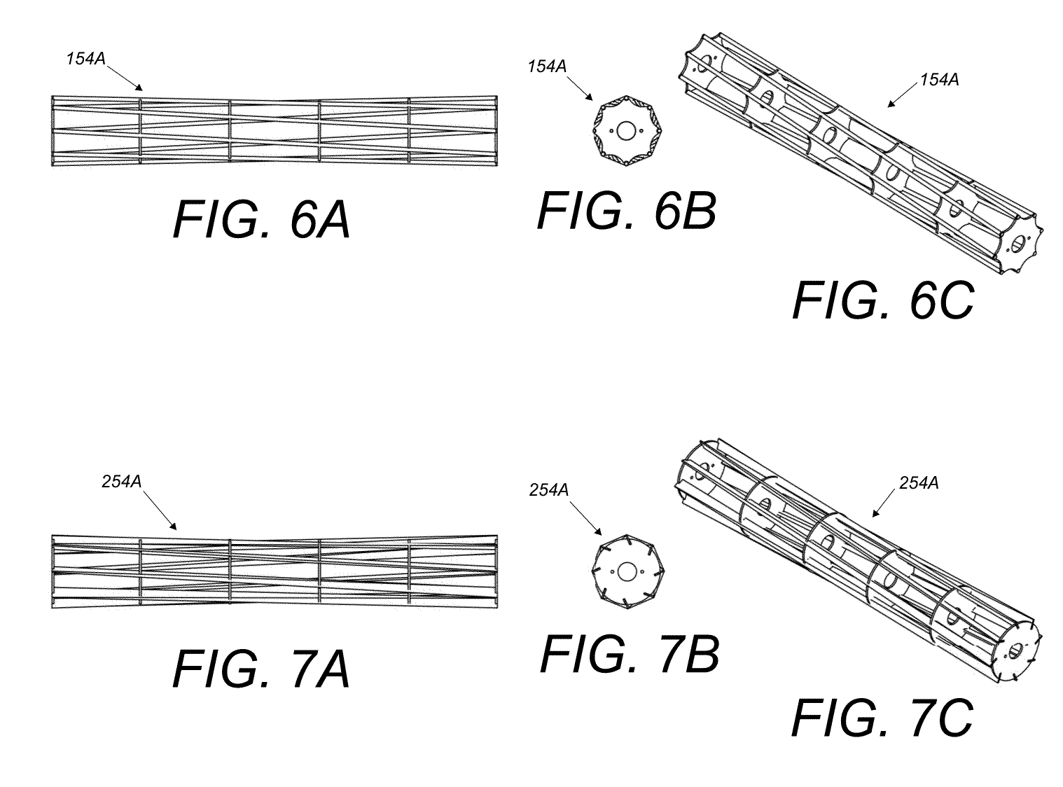

FIG. 1 is a top frontal isometric view of one embodiment of the folding furrow chopper. The folding furrow chopper 50 is designed to be towed by a suitable motorized vehicle, such as a farm tractor (not shown), over a field 52 for preparation and configuration for planting. Arrow 10 depicts the operational direction of folding furrow chopper 50. Folding furrow chopper 50 includes a rigid center frame member 54 and one or more outboard, foldable wing members 56 and 57 that may be selectively rotated between the extended-working position illustrated in FIG. 1 and a folded-transport or storage position illustrated in FIG. 3. In one embodiment, folding furrow chopper 50 includes both foldable wing members 56 and 57. Foldable wing members 56 and 57 may be selectively locked in either the extended-working position illustrated in FIG. 1 or the folded-transport or storage position illustrated in FIG. 3 for safety and stability. Center frame member 54 and foldable wing members 56 and 57 support and contain stalk cutter baskets (also sometimes referred to as the cutter baskets). Although depicted as cylindrical rollers 54A, 56A, and 57A, respectively, in FIG. 1 and FIGS. 9-15, it is to be understood that in a preferred embodiment of the folding furrow chopper, cylindrical rollers 54A, 56A, and 57A are 16 inch diameter stalk cutter baskets with a plurality of blades that may be replaceable and which are depicted in FIGS. 2-5. FIGS. 6A-C show an alternative embodiment cutter basket 154A. FIGS. 7A-C show yet another alternative embodiment cutter basket 254A.

Folding wing members 56 and 57 are connected to center frame member 54 and controlled by arms 72. In one embodiment, a pair of angularly inclined arms 72 are disposed on opposite top ends of both the front and rear of center frame member 54 and pivotally extend at an acute angle toward wing members 56 and 57. Each of arms 72 pivotally terminate on the front and rear edges of bordering ends of wing members 56 and 57, respectively, and are configured to manipulate wing members 56 and 57 between the extended-working position and the folded-transport or storage position. In another embodiment, arms 72 include hydraulic cylinders suitable for extending and folding wing members 56 and 57. Hydraulic cylinders of this type are commonly available from various manufacturers. One suitable model of such cylinders is a 4 inch by 8 inch hydraulic cylinder manufactured by Monarch Industries of Winnipeg, Canada.

Folding furrow chopper 50 may include a plurality of downwardly projecting plowshares 59 that are moveably attached to rigid beams 58A, 58B, and 58C. Rigid beams 58B, 58A, and 58C are attached to the front of wing member 56, the front of center frame member 54, and the front of wing member 57, respectively. As folding furrow chopper 50 is drawn about field 52, plowshares 59 engage the ground and dig irrigation furrows that produce raised earthen mounds between the furrows. Gauge wheel assemblies 62 may be connected to rigid beams 58A and 58C and serve to provide additional support for folding furrow chopper 50 as it is towed through field 52.

The raised earthen mounds created by the soil pushed up from the furrows dug by plowshares 59 become the seed beds for the desired crops. Cutter baskets 54A, 56A, and 57A chop and flatten any crops or crop remains that may be present in the seed bed.

FIG. 2 depicts a double set of crumbler baskets 84 which may be mounted directly behind center frame member 54 and one or more outboard, foldable wing members 56 and 57. In one embodiment, the forward crumbler basket is 12.5 inches in diameter and has eight blades for further chopping and mixing crop and crop remains that may be present in the seed bed and the rearward crumbler basket is 12.5 inches in diameter and has eight round bar blades for even further mixing crop and crop remains that may be present in the seed bed and compacting and packing the seed bed in preparation for planting.

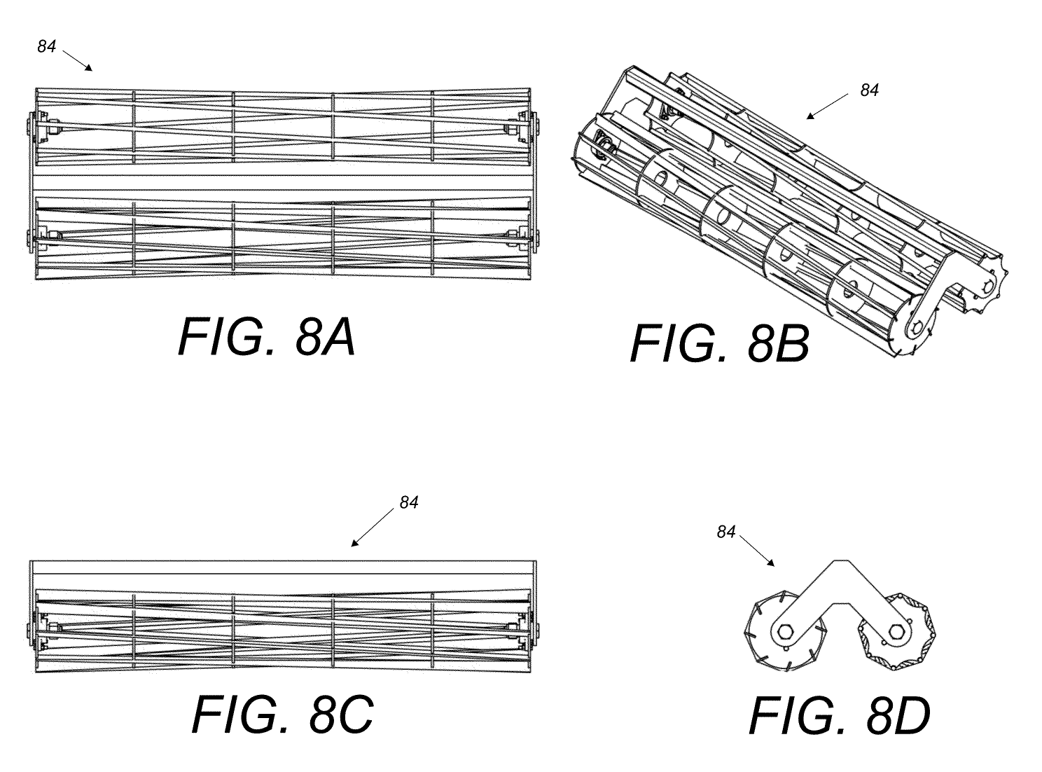

FIGS. 3 through 10 are additional depictions of the cutter baskets and the crumbler baskets 84 and include components thereof, including one manner of affixing the forward and rearward cutter and crumbler baskets by way of the a-frame implement depicted in FIGS. 2, 3 and 8.

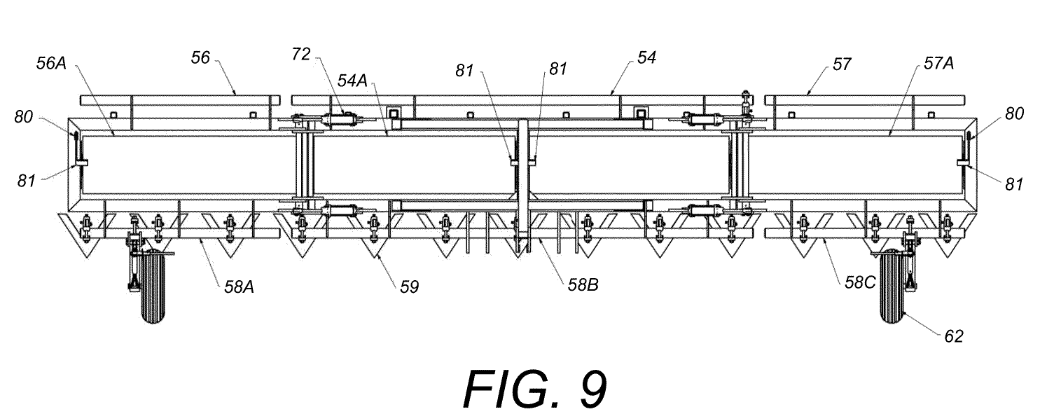

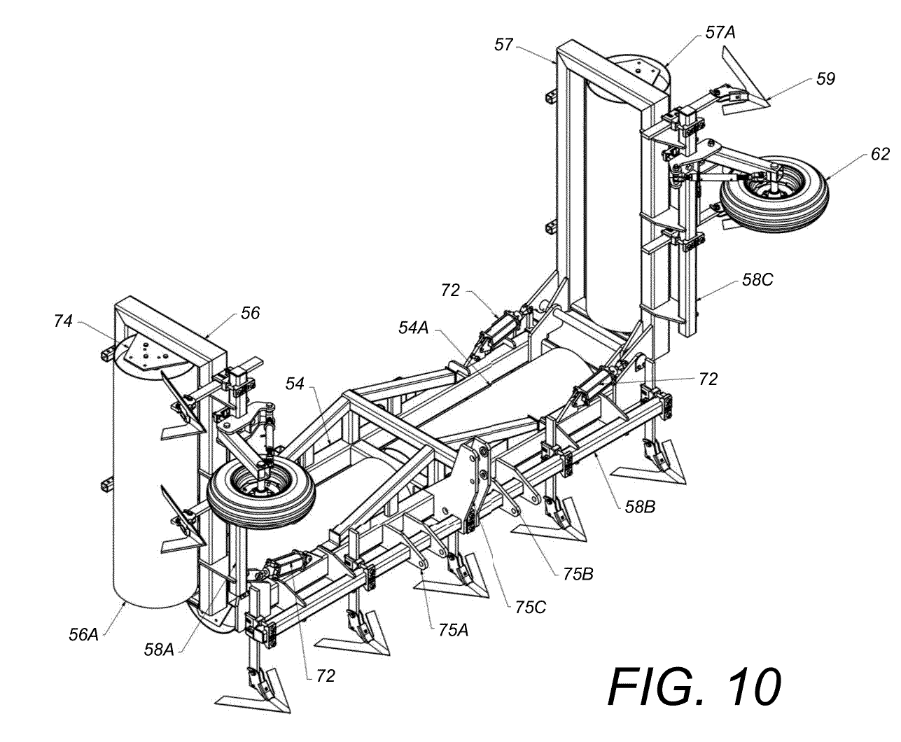

FIG. 9 is a top plan view of an embodiment with wing members 56 and 57 deployed in the extended-working position for operation, and depicts each of the elements of folding furrow chopper 50 shown in FIG. 1. Wing members 56 and 57 are not required to be the same length. Further, while center frame member 54 may be the same length as either of wing members 56 or 57, center frame member 54 is not required to be the same length as either of wing members 56 or 57. In one embodiment, wing members 56 and 57 are the same length and center frame member 54 is longer than wing members 56 and 57. In one embodiment, wing members 56 and 57 are between 99 and 100 inches in length and center frame member 54 is 180 inches in length. In yet another embodiment, wing members 56 and 57 are between 128 and 129 inches in length and center frame member 54 is between 228 and 229 inches in length.

FIG. 10 is a top frontal isometric view of one embodiment with wing members 56 and 57 depicted in a folded-transport or storage position that may be used for transport and storage of folding furrow chopper 50. FIG. 3 depicts each of the elements of folding furrow chopper 50 shown in FIG. 1. In one embodiment of folding furrow chopper 50, center frame member 54 and wing members 56 and 57 are rigid rectangular welded tubular steel frames. In one embodiment, the tubular steel frames from which center frame member 54 and wing members 56 and 57 are constructed are 5/16 inch thick steel and have an outer dimension of 5 inches by 7 inches. It will be appreciated that stalk cutter baskets 54A, 56A, and 57A may be constructed of any material suitable for cutting and chopping crops and are connected to center frame member 54 and wing members 56 and 57 by way of stub shafts commonly known to those with ordinary skill in the relevant art. In one embodiment, concentrically through each of stalk cutter baskets 54A, 56A, and 57A is an interior steel axle. In an alternative embodiment, center frame member 54 and wing members 56 and 57 may contain two or more stalk cutter baskets.

Hitch connectors 75A, 75B, and 75C include suitable pin holes and are connected to the front side of center frame member 54 and rigid beam 58B and permit folding furrow chopper 50 to be connected by way of a standard three-point hitch, a connection device commonly known to those with ordinary skill in the farm implement industry, to a suitable motorized vehicle, such as a farm tractor (not shown). The typical distance from the pin hole of top hitch connector 75C to the center of stalk cutter baskets 54A (hereinafter, the “centerline measurement”) is 50 inches or more. In one embodiment, the centerline measurement is less than 50 inches so as to substantially improve the ability of the applicable motorized towing device to lift folding furrow chopper 50 and disengage folding furrow chopper 50 from the ground particularly when wing members 56 and 57 are in a deployed extended-working position. In one embodiment, the centerline measurement is 34 inches.

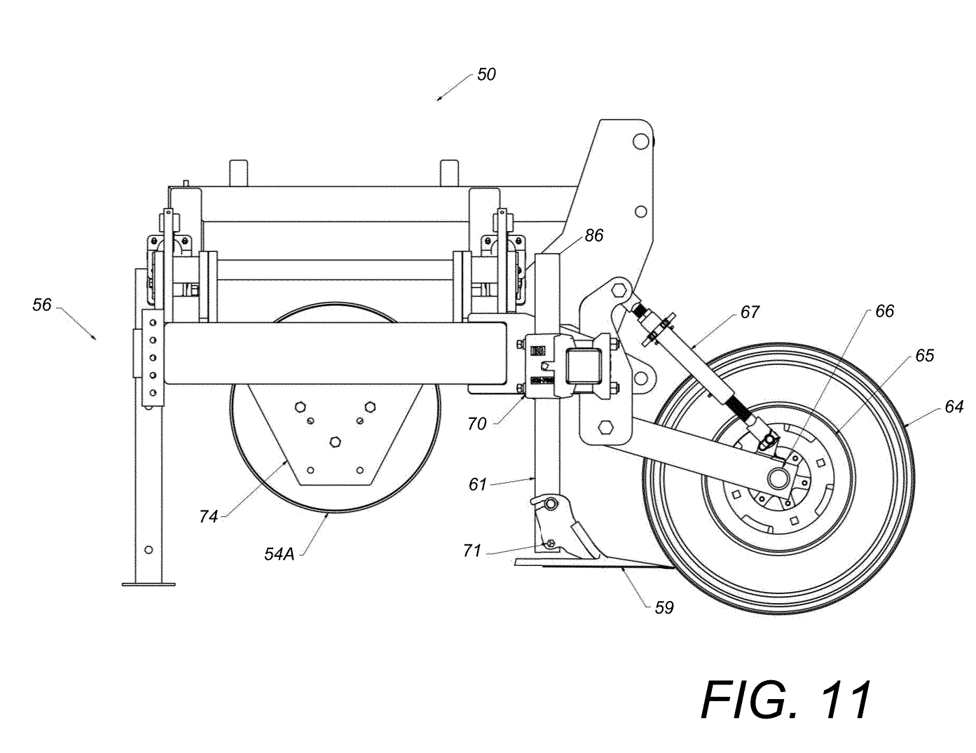

FIG. 11 is a sectional elevation view from FIG. 2 showing gauge wheel assembly 62 according to one embodiment. In one embodiment, additional support for folding furrow chopper 50 is provided by a pair of gauge wheel assemblies 62 disposed substantially at each end of wing members 56 and 57. Adjuster 61 permits variable vertical and angular positioning of each of plowshares 59. In one embodiment, adjuster 61 includes a beam 86 vertically slideable in a fixed sleeve 70 and a plate 71 angularly moveable on the slideable beam, both mechanisms commonly understood by those with ordinary skill in the relevant art. Gauge wheel assembly 62 may include a tire 64, wheel 65, and axle 66, and is attached to wing member 56 with commonly understood struts that may include adjustable linkages 67.

In addition to support for wing members 56 and 57, in one embodiment, gauge wheel assembly 62 provides, in cooperation with the three-point hitch connection, a means of affecting and gauging the vertical displacement of center frame member 54 and wing members 56 and 57 (and thereby, each of the corresponding stalk cutter baskets—with stalk cutter baskets 56A depicted here) when wing members 56 and 57 are parallel and locked to center frame member 54 in their deployed extended-working position. Although not shown, it should be apparent to those skilled in the art that one or more gauge wheel assemblies may also be connected to center frame member 54 so as to provide additional support for folding furrow chopper 50. In another embodiment, gauge wheel assemblies are disposed substantially at each end of center frame member 54. In another embodiment, gauge wheel assemblies are not utilized.

In one embodiment of the present invention, cylindrical rollers 54A, 56A, and 57A are constructed of steel pipe closed on the ends with welded steel discs. In the preferred embodiment of the present invention, concentrically through each of cylindrical rollers 54A, 56A, and 57A is an interior steel axle (not shown) having a diameter of 2.25 inches, both ends of which terminate in a pillow block 74, a bearing support commonly understood by those with ordinary skill in the relevant art. In an alternative embodiment, center frame member 54 and wing members 56 and 57 may contain two or more cylindrical rollers

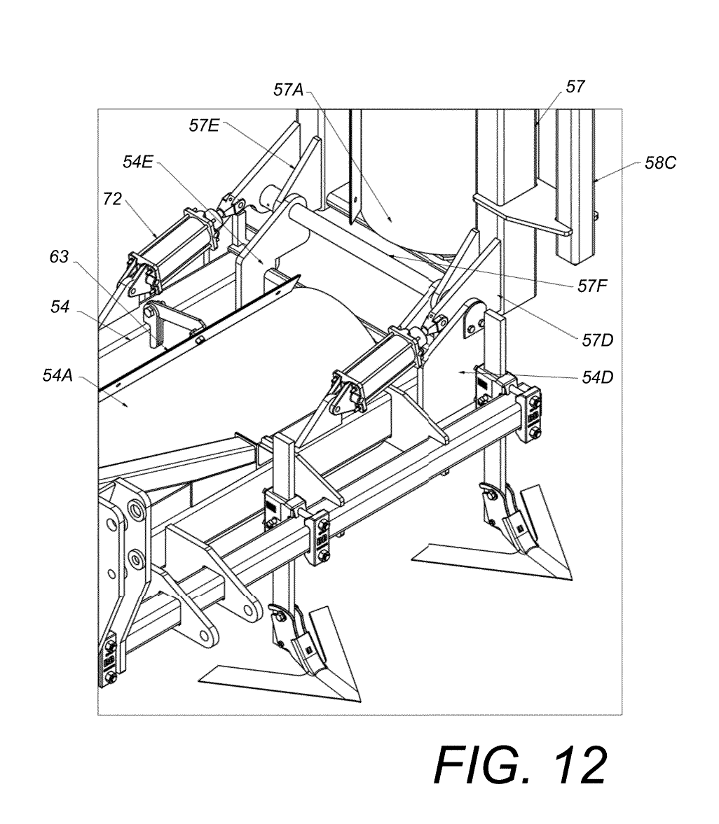

FIG. 12 is a partial isometric top view from FIG. 3. In one embodiment, scraper plate 63 while depicted is not utilized or connected.

At any convenient location, pivot mount 80 is attached so that L-shaped locking lug 81 may pivot and be capable of engaging a slot 82 in stalk cutter baskets 54A configured to receive L-shaped locking lug 81, and thereby, prevent rotation of stalk cutter baskets 54A. Pivot mount 80 is particularly useful when folding furrow chopper 50 is in a folded-transport or storage position for storage or transport. Locking lug 81 may be pinned or cabled or otherwise configured so as to be prevented from engaging slot 82 during operation of folding furrow chopper 50. In one, pivot mount 80 is attached to hinge plate 54E of center frame member 54. Although not shown, it should be apparent to those skilled in the art that the foregoing description with respect to pivot mount 80, locking lug 81, and slot 82 may be applied to each of wing members 56 and 57 and each of stalk cutter baskets 56A and 57A as well as to center frame member 54 and stalk cutter baskets 54A.

Wing members 56 and 57 are pivotally connected to center frame member 54 by way of hinge plates or other suitable connection devices. In one embodiment, pair of hinge plates 54D and 54E are located on opposite top ends of center frame member 54 (on each of the front and rear edges of these top ends of center frame member 54), and wing member 57 has a pair of hinge plates 57D and 57E on the top end of wing member 57 located adjacent to center frame member 54 configured so as to pivotally connect to center frame member 54. Each pair of hinge plates 54D and 54E is configured to receive each corresponding pair of hinge plates 57D and 57E. In one embodiment, hinge plates 54D and 54E are on the outside edges of hinge plates 57D and 57E, respectively. Each pair of hinge plates 54D, 54E, 57D, and 57E are configured to be pivotally connected to one another using stub shafts or other suitable connection means well known to those with ordinary skill in the relevant art. In one embodiment, each pair of hinge plates 54D, 54E, 57D, and 57E is pivotally connected to each other by way of hinge pin 57F which traverses the entire distance from hinge plate 54D on the front edge of center frame member 54 to hinge plate 54D on the rear edge of center frame member 54 so as to provide maximum resistance to axial and torsional forces that may be encountered by wing member 57. In one embodiment, hinge pin 57F is a solid steel shaft having a diameter of at least 2 inches. Also in one embodiment, arms 72 include hydraulic cylinders. With respect to the one of these hydraulic cylinders, one end is connected to hinge plate 57D on the front edge of wing member 57 and the other end is connected to the front edge of center member 54. With respect to another of these hydraulic cylinders, one end is connected to hinge plate 57D on the rear edge of wing member 57 and the other end is connected to the rear edge of center member 54. The connection of arms 72 to each of hinge plates 57D provides the improved benefit of allowing arms 72 to pull from points close to the pivot points of wing frame 57, and thereby, avoid the need for long connecting arms that are subject to torsional and potentially damaging bending forces. Although not shown, it should be apparent to those skilled in the art that the foregoing description with respect to the connection of wing member 57 to center frame member 54 and the connection of arms 72 to each of hinge plates 57D may be applied to the pivotal connection of wing member 56 to the opposite end of center frame member 54.

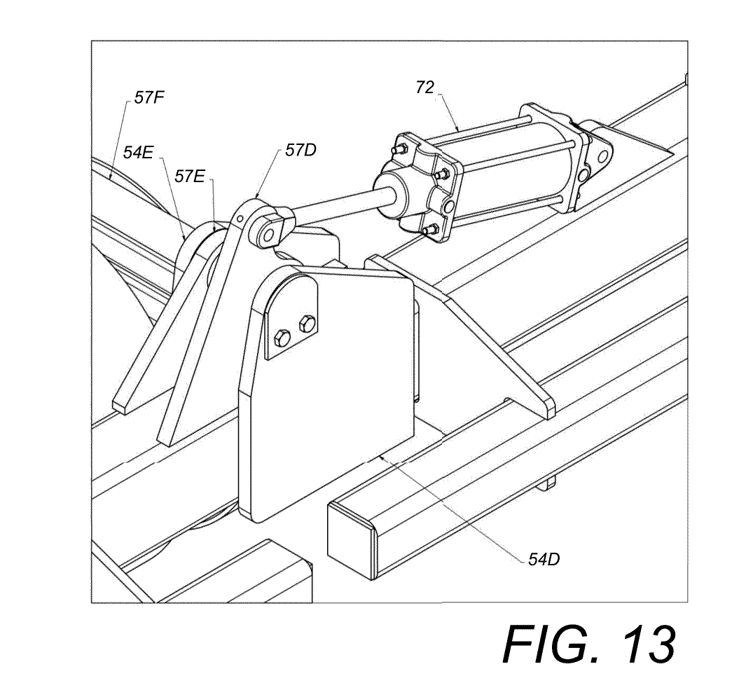

FIG. 13 is a partial enlarged isometric view of arm 72 (which is depicted as hydraulic cylinder) connected to hinge plate 57D and a cylinder lock 121 according to one embodiment. Cylinder lock 121 permits hydraulic cylinder 72 to be selectively locked after wing members 56 and 57 are rotated into their extended-working position or their folded-transport or storage position.

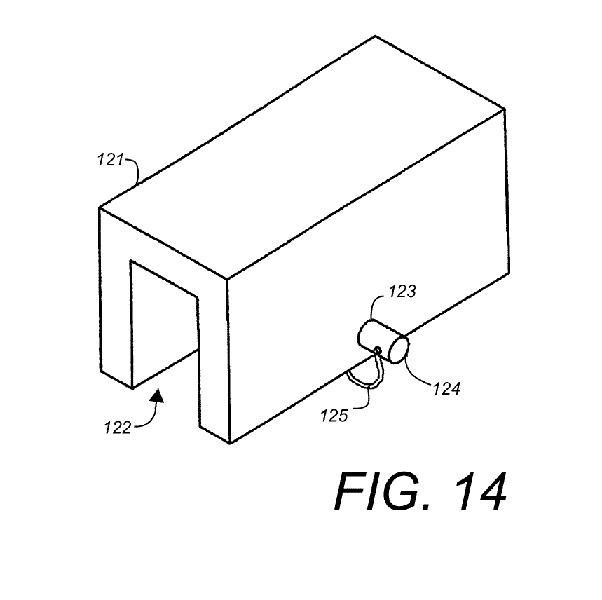

FIG. 14 is an isometric view of cylinder lock 121 from FIG. 6. Cylinder lock 121 is a U-shaped steel block having an open region 122 configured to receive an exposed ram of hydraulic cylinder 72 having a through-hole that lines up with a hole in each leg of the U-shaped-block of cylinder lock 121 so that a removable retainer pin 124, normally held by a retainer cable 125 which is connected to cylinder lock 121 penetrates, through the exposed ram of hydraulic cylinder 72 and the opposing legs of lock 121 to lock hydraulic cylinder 72 in the desired position. Cylinder lock 121 may be used to lock wing members 56 and 57 in a deployed extended-working position. Further, cylinder lock 121 may be configured to lock wing members 56 and 57 in a folded transport or storage position. When not in use, cylinder lock 121 may be pinned to any convenient member of folding furrow chopper 50 capable of fitting in open region 122 and having a receiver hole 123 capable of receiving pin 124.

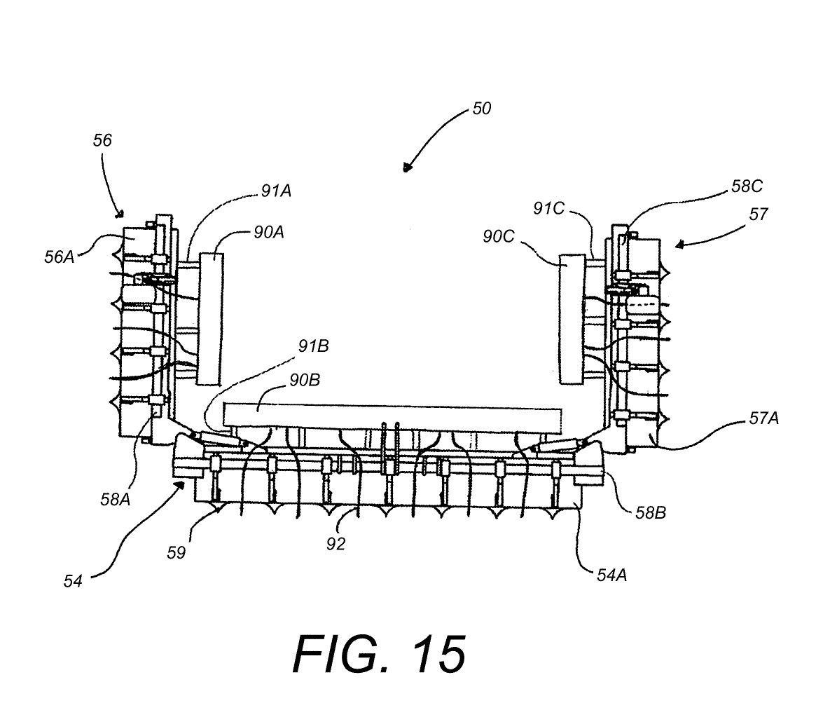

FIG. 15 is frontal view of an embodiment with wing members 56 and 57 in the folded-transport or storage position. Seeder bins 90A, 90B, and 90C may be selectively mounted (in positions other than as depicted) by way of mounting arms 91A, 91B, and 91C, and are configured to hold seed. Feeder tubes 92 are connected to seeder bins 90A, 90B, and 90C, respectively, and configured for lateral adjustment so as to be centered between each of plowshares 59. In one embodiment, feeder tubes 92 are positioned so as to be substantially perpendicular to seeder bins 90A, 90B, and 90C and substantially parallel to each of plowshares 59. In another embodiment seeder bins 90A, 90B, and 90C are configured to be connected to the rear of center frame member 54 and foldable wing members 56 and 57. In yet another embodiment, a single seeder bin may be connected to the rear of furrow chopper 50. As furrow chopper 50 is drawn through the field, plowshares 59 dig irrigation furrows that produce raised earthen mounds between the furrows, seeds from seeder bins 90A, 90B, and 90C flow through feeder tubes 92 are deposited into the raised earthen mounds produced by plowshares 59, and stalk cutter baskets 54A, 56A, and 57 and the forward and rearward crumbler baskets so as to chop and cut crops and crop remains that might be present so as to smooth and compact these raised earthen mounds and thereby create uniform, raised, and planted seed beds separated by uniform irrigation furrows concurrently in one operation.

In one embodiment, the cutter basket may be replaced with the referenced and depicted cylindrical rollers. In another embodiment, the forward and rear crumbler baskets may be selectively removed. Further, one embodiment utilizes a 16″ diameter stalk-cutter basket with five replaceable beveled blades and a double set of 12½″ crumbler baskets mounted on the back of the frame. The front 12¼″ diameter crumbler basket has eight ¼″×2″ blades and the back 12½″ diameter basket has eight ¾″ round bar blades and adjustable “S-Tine” furrow assist may be connected to the rear of the frame or crumbler baskets to assist with making each of the furrows uniform. The present invention permits farmers to plant crops in fields after using the invention one time in the field to clear the old crop remains.

In one embodiment, the cutter baskets and the cylindrical rollers may be geared such that their rotation may be selectively engaged during operation to permit selected baskets and rollers to rotate in a direction opposite to the rotation of the other baskets and rollers. While the gearing mechanisms are not depicted in the figures, it will be appreciated that such mechanisms are known to those skilled in the art.

### III. Folding Furrow Crumbler/Tumbler

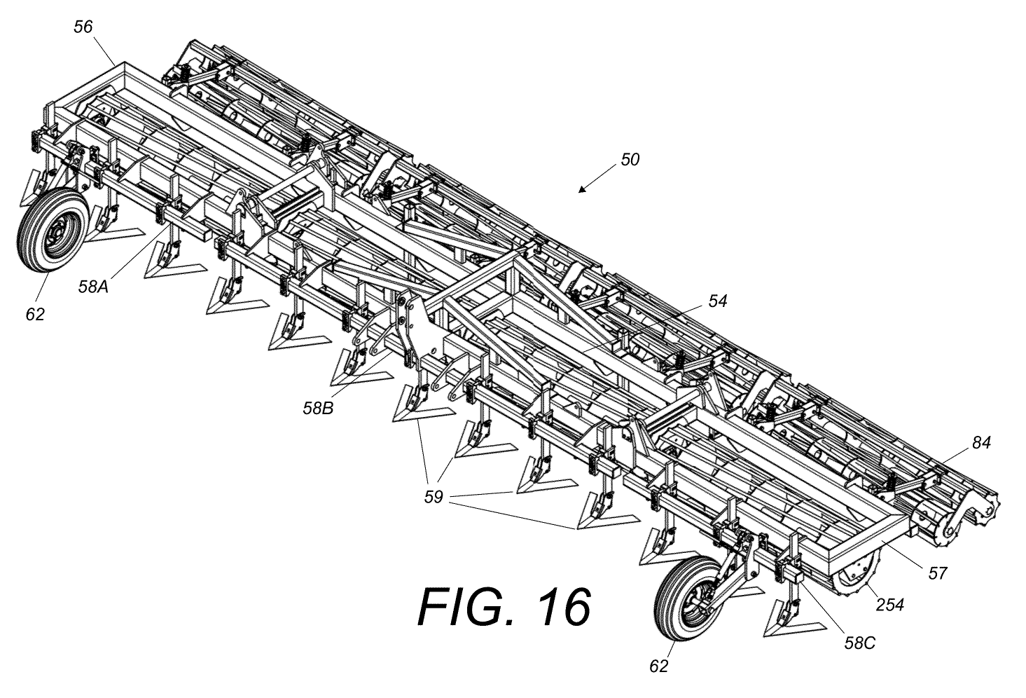

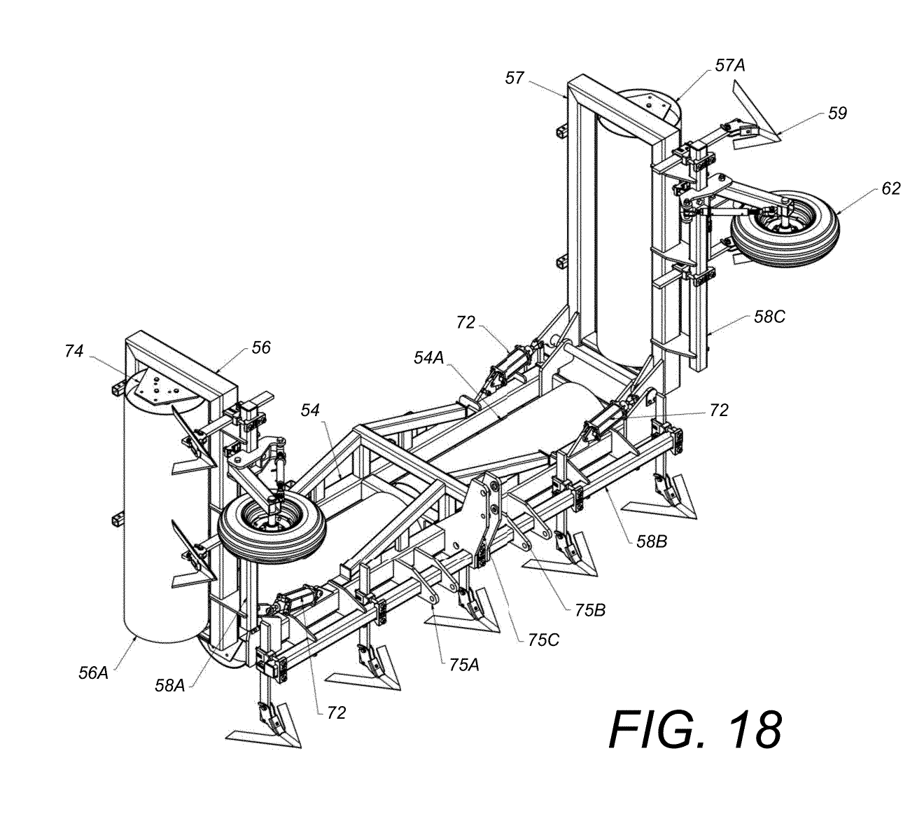

FIG. 16 is a top frontal isometric view of one embodiment of the folding furrow crumbler (or tumbler). Folding furrow crumbler 50 is designed to be towed by a suitable motorized vehicle, such as a farm tractor (not shown), over a field 52 for preparation and configuration for planting. Arrow 10 depicts the operational direction of folding furrow crumbler 50. Folding furrow crumbler 50 includes a rigid center frame member 54 and one or more outboard, foldable wing members 56 and 57 that may be selectively rotated between the extended-working position illustrated in FIG. 18 and a folded-transport or storage position illustrated in FIG. 12. In one embodiment, folding furrow crumbler 50 includes both foldable wing members 56 and 57. Foldable wing members 56 and 57 may be selectively locked in either the extended-working position illustrated in FIG. 18 or the folded-transport or storage position illustrated in FIG. 12 for safety and stability. Center frame member 54 and foldable wing members 56 and 57 support and contain crumbler baskets, with each crumbler basket further including crumbling rods (also sometimes referred to as the crumbler rods). Although depicted as cylindrical rollers 54A, 56A, and 57A, respectively, in FIGS. 18-25, it is to be understood that in one embodiment, cylindrical rollers 54A, 56A, and 57A are crumbling rods with a plurality of round bar blades or rods that may be replaceable.

Folding wing members 56 and 57 are connected to center frame member 54 and controlled by arms 72. In one embodiment, a pair of angularly inclined arms 72 are disposed on opposite top ends of both the front and rear of center frame member 54 and pivotally extend at an acute angle toward wing members 56 and 57. Each of arms 72 pivotally terminate on the front and rear edges of bordering ends of wing members 56 and 57, respectively, and are configured to manipulate wing members 56 and 57 between the extended-working position and the folded-transport or storage position. In one embodiment, arms 72 include hydraulic cylinders suitable for extending and folding wing members 56 and 57. Hydraulic cylinders of this type are commonly available from various manufacturers. One suitable model of such cylinders is a 4 inch by 8 inch hydraulic cylinder manufactured by Monarch Industries of Winnipeg, Canada.

Folding furrow crumbler 50 may include a plurality of downwardly projecting plowshares 59 that are moveably attached to rigid beams 58A, 58B, and 58C. Rigid beams 58B, 58A, and 58C are attached to the front of wing member 56, the front of center frame member 54, and the front of wing member 57, respectively. As folding furrow crumbler 50 is drawn about field 52, plowshares 59 engage the ground and dig irrigation furrows that produce raised earthen mounds between the furrows. Gauge wheel assemblies 62 may be connected to rigid beams 58A and 58C and serve to provide additional support for folding furrow crumbler 50 as it is towed through field 52.

The raised earthen mounds created by the soil pushed up from the furrows dug by plowshares 59 become the seed beds for the desired crops. Crumbling rods 54A, 56A, and 57A crumble any dirt clods that may be present in the seed bed and create uniform seed beds for planting.

In one embodiment, folding furrow crumbler 50 may include 24 inch diameter crumbler baskets with sixteen 1 inch round bars (crumbler rods), a double set of 12½ inch crumbler baskets, the front baskets having eight ¼ inch×2 inch blades and the back baskets having eight ¾ inch round bars, two heavy duty adjustable gauge wheels with 11 L×15 tires, two adjustable hydraulic markers, and a Category 3/3N three-point hitch.

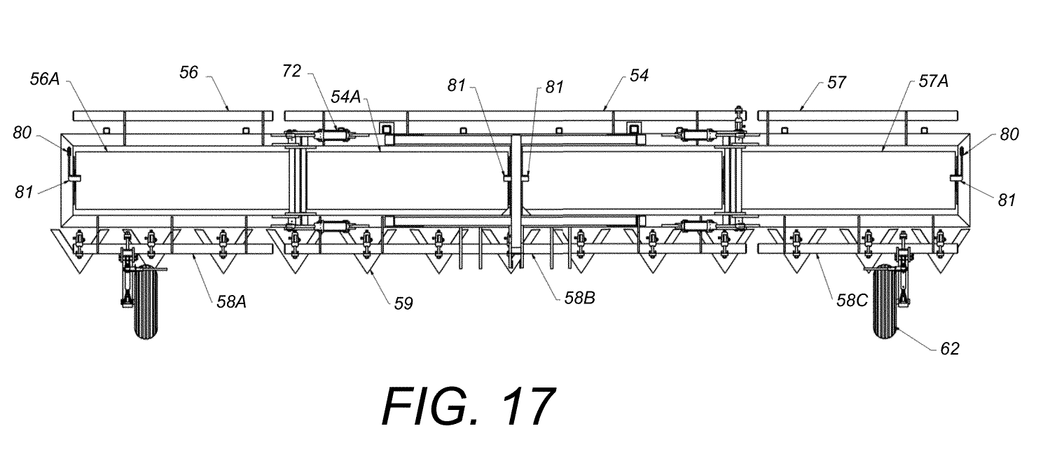

FIG. 17 is a top plan view of one embodiment with wing members 56 and 57 deployed in the extended-working position for operation, and depicts each of the elements of folding furrow crumbler 50 shown in FIG. 18. Wing members 56 and 57 are not required to be the same length. Further, while center frame member 54 may be the same length as either of wing members 56 or 57, center frame member 54 is not required to be the same length as either of wing members 56 or 57. In one embodiment, wing members 56 and 57 are the same length and center frame member 54 is longer than wing members 56 and 57. In one embodiment, wing members 56 and 57 are between 99 and 100 inches in length and center frame member 54 is 180 inches in length. In yet another embodiment, wing members 56 and 57 are between 128 and 129 inches in length and center frame member 54 is between 228 and 229 inches in length.

FIG. 18 is a top frontal isometric view of one embodiment with wing members 56 and 57 depicted in a folded-transport or storage position that may be used for transport and storage of folding furrow crumbler 50. FIG. 12 depicts each of the elements of folding furrow crumbler 50 shown in FIG. 16. In one embodiment of folding furrow crumbler 50, center frame member 54 and wing members 56 and 57 are rigid rectangular welded tubular steel frames. In one embodiment, the tubular steel frames from which center frame member 54 and wing members 56 and 57 are constructed are 5/16 inch thick steel and have an outer dimension of 5 inches by 7 inches. It will be appreciated that crumbling rods 54A, 56A, and 57A may be constructed of any material suitable for crumbling dirt clods and are connected to center frame member 54 and wing members 56 and 57 by way of stub shafts commonly known to those with ordinary skill in the relevant art. In one embodiment, concentrically through each of crumbling rods 54A, 56A, and 57A is an interior steel axle. In an alternative embodiment, center frame member 54 and wing members 56 and 57 may contain two or more crumbling rods.

Hitch connectors 75A, 75B, and 75C include suitable pin holes and are connected to the front side of center frame member 54 and rigid beam 58B and permit folding furrow crumbler 50 to be connected by way of a standard three-point hitch, a connection device commonly known to those with ordinary skill in the farm implement industry, to a suitable motorized vehicle, such as a farm tractor (not shown). The typical distance from the pin hole of top hitch connector 75C to the center of crumbling rods 54A (hereinafter, the “centerline measurement”) is 50 inches or more. In one embodiment, the centerline measurement is less than 50 inches so as to substantially improve the ability of the applicable motorized towing device to lift folding furrow crumbler 50 and disengage folding furrow crumbler 50 from the ground particularly when wing members 56 and 57 are in a deployed extended-working position. In one embodiment, the centerline measurement is 34 inches.

Referring back to FIG. 11, which is a sectional elevation view from FIG. 18 showing gauge wheel assembly 62 according to one embodiment. In one embodiment, additional support for folding furrow crumbler 50 is provided by a pair of gauge wheel assemblies 62 disposed substantially at each end of wing members 56 and 57. Adjusting means 61 permits variable vertical and angular positioning of each of plowshares 59. In one embodiment, adjusting means 61 includes a beam vertically slideable in a fixed sleeve 70 and a plate 71 angularly moveable on the slideable beam, both mechanisms commonly understood by those with ordinary skill in the relevant art. Gauge wheel assembly 62 may include a tire 64, wheel 65, and axle 66, and is attached to wing member 56 with commonly understood struts that may include adjustable linkages 67. In addition to support for wing members 56 and 57, in one embodiment, gauge wheel assembly 62 provides, in cooperation with the three-point hitch connection, a means of affecting and gauging the vertical displacement of center frame member 54 and wing members 56 and 57 (and thereby, each of the corresponding crumbling rods—with crumbling rods 56A depicted here) when wing members 56 and 57 are parallel and locked to center frame member 54 in their deployed extended-working position. Although not shown, it should be apparent to those skilled in the art that one or more gauge wheel assemblies may also be connected to center frame member 54 so as to provide additional support for folding furrow crumbler 50. In another embodiment, gauge wheel assemblies are disposed substantially at each end of center frame member 54. In another embodiment, gauge wheel assemblies are not utilized.

Referring back to FIG. 12, which is a partial isometric top view from FIG. 18. In one embodiment, scraper plate 63 while depicted is not utilized or connected. At any convenient location, pivot mount 80 is attached so that L-shaped locking lug 81 may pivot and be capable of engaging a slot 82 in crumbling rods 54A configured to receive L-shaped locking lug 81, and thereby, prevent rotation of crumbling rods 54A. Pivot mount 80 is particularly useful when folding furrow crumbler 50 is in a folded-transport or storage position for storage or transport. Locking lug 81 may be pinned or cabled or otherwise configured so as to be prevented from engaging slot 82 during operation of folding furrow crumbler 50. In one embodiment, pivot mount 80 is attached to hinge plate 54E of center frame member 54. Although not shown, it should be apparent to those skilled in the art that the foregoing description with respect to pivot mount 80, locking lug 81, and slot 82 may be applied to each of wing members 56 and 57 and each of crumbling rods 56A and 57A as well as to center frame member 54 and crumbling rods 54A.

Wing members 56 and 57 are pivotally connected to center frame member 54 by way of hinge plates or other suitable connection devices. In one embodiment, pair of hinge plates 54D and 54E are located on opposite top ends of center frame member 54 (on each of the front and rear edges of these top ends of center frame member 54), and wing member 57 has a pair of hinge plates 57D and 57E on the top end of wing member 57 located adjacent to center frame member 54 configured so as to pivotally connect to center frame member 54. Each pair of hinge plates 54D and 54E is configured to receive each corresponding pair of hinge plates 57D and 57E. In one embodiment, hinge plates 54D and 54E are on the outside edges of hinge plates 57D and 57E, respectively. Each pair of hinge plates 54D, 54E, 57D, and 57E are configured to be pivotally connected to one another using stub shafts or other suitable connection means well known to those with ordinary skill in the relevant art. In one embodiment, each pair of hinge plates 54D, 54E, 57D, and 57E is pivotally connected to each other by way of hinge pin 57F which traverses the entire distance from hinge plate 54D on the front edge of center frame member 54 to hinge plate 54D on the rear edge of center frame member 54 so as to provide maximum resistance to axial and torsional forces that may be encountered by wing member 57. In one embodiment, hinge pin 57F is a solid steel shaft having a diameter of at least 2 inches. Also in one embodiment, arms 72 include hydraulic cylinders. With respect to one of these hydraulic cylinders, one end is connected to hinge plate 57D on the front edge of wing member 57 and the other end is connected to the front edge of center member 54. With respect to another of these hydraulic cylinders, one end is connected to hinge plate 57D on the rear edge of wing member 57 and the other end is connected to the rear edge of center member 54. The connection of arms 72 to each of hinge plates 57D provides the improved benefit of allowing arms 72 to pull from points close to the pivot points of wing frame 57, and thereby, avoid the need for long connecting arms that are subject to torsional and potentially damaging bending forces. Although not shown, it should be apparent to those skilled in the art that the foregoing description with respect to the connection of wing member 57 to center frame member 54 and the connection of arms 72 to each of hinge plates 57D may be applied to the pivotal connection of wing member 56 to the opposite end of center frame member 54.

It will be apparent to those with ordinary skill in the relevant art having the benefit of this disclosure that the present invention provides a foldable furrow chopper and a folding furrow crumbler/tumbler with deployable wing members that is highly stabilized when deployed, but capable of easy reconfiguration for stable use, and for easy and legal transport. It is understood that the forms of the invention shown and described in the detailed description and the drawings are to be taken merely as presently preferred examples and that the invention is limited only by the language of the claims.

While the present invention has been described in terms of one preferred embodiment and a few variations thereof, it will be apparent to those skilled in the art that form and detail modifications may be made to those embodiments without departing from the spirit or scope of the invention.

Having thus described the invention, what is claimed as new and desired to be secured by Letters Patent is:

1. A folding farm implement capable of being towed by a vehicle, the implement comprising:
a substantially rectangular center frame member having a front edge, a rear edge, and two side edges;
at least one substantially rectangular wing member, each wing member having a front edge, a rear edge, and two side edges;
a plurality of center frame member hinge plates mounted on the center frame member, wherein at least one of the center frame member hinge plates is proximate to the front edge and the first of the side edges of the center frame member, and further wherein, at least one of the center frame member hinge plates is proximate to the rear edge and the first of the side edges of the center frame member;
a plurality of wing member hinge plates mounted on each wing member, wherein at least one of the wing member hinge plates is proximate to the front edge and the first of the side edges of each wing member, and further wherein, at least one of the wing member hinge plates is proximate to the rear edge and the first of the side edges of each wing member, and further wherein the plurality of center frame member hinge plates are configured to be pivotally connected to the plurality of wing member hinge plates so as to permit any of the wing members to be connected to the first of the side edges of the center frame member;
at least one hitch connector mounted to the agricultural implement and configured for connecting the agricultural implement to a suitable towing device;
a hinge pin wherein each of the plurality of center frame member hinge plates and each of the plurality of wing member hinge plates are configured to receive the hinge pin, and further wherein the hinge pin traverses substantially the distance of the first of the side edges of the center frame member and connects each of the plurality of center frame member hinge plates and each of the plurality of wing member hinge plates mounted to the first of the side edges of the center frame member and to one of the side edges of the connected wing member, respectively;
a plurality of hydraulic cylinders configured to rotate said wing member connected to the first of the side edges of the center frame member wherein at least one of the hydraulic cylinders communicates between the front edge of the center frame member and the wing member hinge plate proximate to the front edge of the wing member, and further wherein at least one of the hydraulic cylinders communicates between the rear edge of the center frame member and the wing member hinge plate proximate to the rear edge of the wing member;
a first double set of crumbler baskets mounted directly behind said center frame member, and a second double set of crumbler baskets mounted directly behind said wing member;
wherein said at least one substantially rectangular wing member is capable of being rotated between a first, extended-working position substantially parallel to and outboard of the first of the side edges of the center frame member, and a second, substantially vertical, folded-transport position above and perpendicular to the first of the side edges of the center frame member; and
wherein said second double set of crumbler baskets is rotated between said first and second positions along with said wing member.

2. The agricultural implement of claim 1 wherein the plurality of center member hinge plates and the plurality of wing member hinge plates are configured so as to permit a connected wing member when in the second folded-transport or storage position to be substantially inboard of the first of the side edges of the center frame member.

3. The agricultural implement of claim 1 further comprising:
a plurality of cylinder locks wherein each cylinder lock is configured to selectively lock the connected wing member in the first extended-working position or the second folded-transport position.

4. The agricultural implement of claim 1 further comprising:
a plurality of gauge wheel assemblies, each said gauge wheel assembly having a wheel and an adjustable linkage;
at least one of said plurality of gauge wheel assemblies moveably attached to said wing member;
wherein when said at least one substantially rectangular wing member is in the first extended-working position, the wheels of the gauge wheel assemblies are in contact with a field over which the agricultural implement is moving; and
wherein the adjustable linkages are configured to maintain a consistent vertical displacement of the connected wing member and the center frame member to the field.

5. The agricultural implement of claim 4 wherein at least one said plurality of gauge wheel assemblies is moveably attached to the center frame member.

6. The agricultural implement of claim 1, further comprising:
said crumbler basked comprising a plurality of replaceable crumbling rods affixed to a central spoke.

7. The agricultural implement of claim 1, further comprising:
a center axle assembly rotatably attached to the side edges of said center frame member; and
a wing axle assembly rotatably attached to the side edges of each of said at least one substantially rectangular wing members.

8. The agricultural implement of claim 7, further comprising:
a first stalk cutter basket concentrically mounted on said center axle; and
a second cutter basket concentrically mounted on said wing axle.

9. The agricultural implement of claim 7, further comprising:
a first cylindrical roller basket concentrically mounted on said center axle; and
a second cylindrical roller concentrically mounted on said wing axle.

10. The agricultural implement of claim 7, further comprising:
a first crumbler basket concentrically mounted on said center axle; and
a second crumbler basket concentrically mounted on said wing axle.

11. The agricultural implement of claim 1 further comprising at least one scraper plate moveably attached to the agricultural implement, the scraper plates positioned in proximity to the cylindrical rollers and configured to continually dislodge accumulations of soil from the cylindrical rollers as the cylindrical rollers rotate.

12. The agricultural implement of claim 1 further comprising a plurality of plow beams moveably attached to the center frame member and to the wing member.

13. The agricultural implement of claim 12 further comprising a plurality of plowshares removeably attached to at least one of the plurality of plow beams.

14. The agricultural implement of claim 12 wherein the plowshares are configured to be vertically and angularly adjustable.

15. The agricultural implement of claim 1 further comprising:
at least one seeder bin; and a plurality of feeder tubes connected to the seeder bins; and
wherein the feeder tubes are configured to be vertically and angularly adjustable.

16. An agricultural implement comprising:
a substantially rectangular center frame member having a front edge, a rear edge, and two side edges, and wherein the front edge, the rear edge, and the two side edges of the center frame member define a planar center frame member opening;
first and second rectangular wing members, each said wing member having a front edge, a rear edge, and two side edges and wherein the front edge, the rear edge, and the two side edges of each of the wing members define a planar wing member opening;
a plurality of center frame member hinge plates mounted on the center frame member, wherein at least one of the center frame member hinge plates is proximate to the front edge and the first of the side edges of the center frame member, and further wherein, at least one of the center frame member hinge plates is proximate to the rear edge and the first of the side edges of the center frame member;
a respective plurality of wing member hinge plates mounted on each of said first and second wing members, wherein at least one of the wing member hinge plates is proximate to the front edge and the first of the side edges of each wing member, and further wherein, at least one of the wing member hinge plates is proximate to the rear edge and the first of the side edges of each wing member, and further wherein the plurality of center frame member hinge plates are configured to be pivotally connected to the plurality of wing member hinge plates so as to permit any of the wing members to be connected to the first of the side edges of the center frame member, and further wherein, once connected, the wing member is capable of being rotated between a first extended-working position substantially parallel to and outboard of the first of the side edges of the center frame member and a second folded-transport or storage position substantially above and perpendicular to the first of the side edges of the center frame member;
at least one hitch connector mounted to the agricultural implement and configured for connecting the agricultural implement to a suitable towing device;
a hinge pin wherein each of the plurality of center frame member hinge plates and each of the plurality of wing member hinge plates are configured to receive the hinge pin, and further wherein the hinge pin traverses substantially the distance of the first of the side edges of the center frame member and connects each of the plurality of center frame member hinge plates and each of the plurality of wing member hinge plates mounted to the first of the side edges of the center frame member and to one of the side edges of the connected wing member, respectively;
at least one center frame member axle assembly rotatably attached to the side edges of the center frame member and spanning the center frame member opening;
a respective at least one wing member axle assembly rotatably attached to the side edges of each of said first and second wing members and spanning the wing member opening;
a plurality of plow beams moveably attached to the center frame member and to each said wing member;
a plurality of plowshares removeably attached to at least one of the plurality of plow beams;
wherein the plowshares are configured to be vertically and angularly adjustable;
a first double set of crumbler baskets mounted directly behind said center frame member, and a second double set of crumbler baskets mounted directly behind said wing member;
wherein said at least one substantially rectangular wing member is capable of being rotated between a first, extended-working position substantially parallel to and outboard of the first of the side edges of the center frame member, and a second, substantially vertical, folded-transport position above and perpendicular to the first of the side edges of the center frame member; and
wherein said second double set of crumbler baskets is rotated between said first and second positions along with said wing member.

17. The agricultural implement of claim 16, further comprising:
a first stalk cutter basket concentrically mounted on said center axle; and
a respective wing cutter basket concentrically mounted on said respective wing axle.

18. The agricultural implement of claim 16, further comprising:
a first cylindrical roller basket concentrically mounted on said center axle; and
a respective wing cylindrical roller concentrically mounted on respective said wing axle.

19. The agricultural implement of claim 16, further comprising:
a first crumbler basket concentrically mounted on said center axle; and
a respective wing crumbler basket concentrically mounted on each respective said wing axle.
